(19) United States
(12) Patent Application Publication
(10) Pub. No.: US 2026/0358578 A1
(43) Pub. Date: Nov. 12, 2026

(54) METHOD OF MANUFACTURING OPTICAL MODULE

(71) Applicant: SUMITOMO ELECTRIC DEVICE INNOVATIONS, INC., Kanagawa (JP)

(72) Inventor: Hiroaki TEZUKA, Kanagawa (JP)

(21) Appl. No.: 19/639,594

(22) Filed: Apr. 6, 2026

(30) Foreign Application Priority Data
May 12, 2025 (JP) 2025-079464

(51) Int. Cl. G02B 6/42

(52) U.S. Cl. CPC G02B 6/4225

(57) ABSTRACT

A method of manufacturing an optical module is a method of manufacturing an optical module including an optical fiber and an optical device, the optical fiber having a core, a cladding covering the core, and a first end surface at which the core and the cladding are exposed, the cladding including a pair of stress application portions, the core being a polarization maintaining fiber located between the pair of stress application portions, the optical device being optically coupled to the optical fiber. The manufacturing method includes causing visible light to enter the optical fiber from an outer periphery of the cladding, detecting the visible light emitted from the first end surface of the optical fiber, and adjusting a relative angle of the optical device with respect to an alignment direction of the pair of stress application portions while determining the alignment direction based on a detection result in the detecting.

### CROSS REFERENCE TO RELATED APPLICATIONS

This application claims priority based on Japanese Patent Application No. 2025-079464 filed on May 12, 2025, and the entire contents of the Japanese patent application are incorporated herein by reference.

### TECHNICAL FIELD

The present disclosure relates to a method of manufacturing an optical module.

### BACKGROUND

Patent literature 1 (Japanese Unexamined Patent Application Publication No. 2008-249913) discloses an optical component mounting method. The purpose of this method is to perform alignment by emitting light without connecting a lead wire of a light emitting element to a drive power supply in a step of assembling and mounting an optical component by fixing the light emitting element including a semiconductor laser to a housing. For this purpose, in the method a semiconductor laser is irradiated with excitation light having a wavelength not longer than a wavelength of the laser light emitted by the semiconductor laser. Thus, the semiconductor laser is put into a photo-excited laser oscillation state without passing a current. The position of the light emitting element is adjusted by monitoring the generated fluorescence or laser light.

Patent literature 2 (Japanese Utility Model Registration No. 3137003) discloses an alignment device in assembling an optical module. In this device, a light emitting side optical component and a light receiving side optical component are relatively movable in XYZ directions. Laser light in the infrared region emitted from the light emitting side optical component is imaged as a visible image on an IR sensor, and the visible image is captured by a visible camera. Based on the captured two-dimensional image, the XYZ-coordinate values of the image are specified by image processing. An optical axis is roughly adjusted based on the specified coordinate value, the light emitting side optical component is operated after the rough adjustment, and the optical axis is further finely adjusted based on the measurement data in the power meter.

Patent literature 3 (WO 2009/069572) discloses a method of manufacturing a receptacle optical module. In this manufacturing method, an optical element having polarization characteristics and held by a joint sleeve having a rotationally symmetric shape is provided between a light emitting and condensing portion including a light emitting element chip and a lens and a receptacle including a fiber stub and detachably holding an external optical fiber. The positional relationship between the light emitting and condensing portion and the fiber stub is aligned to a suboptimal position, and the joint sleeve and an optical element having the polarization characteristics are integrally rotated to obtain a rotation angle at which a desired light quantity is obtained to the external optical fiber. At that angle, the joint sleeve, the light emitting and condensing portion, and the receptacle are welded together.

### SUMMARY OF INVENTION

A method of manufacturing an optical module according to an embodiment of the present disclosure is a method of manufacturing an optical module including an optical fiber and an optical device, the optical fiber being a polarization maintaining fiber having a core, a cladding covering an outer periphery of the core, and a first end surface at which the core and the cladding are exposed, the cladding including a pair of stress application portions, the core being located between the pair of stress application portions, the optical device being optically coupled to the optical fiber. The manufacturing method includes causing visible light to enter the optical fiber from an outer periphery of the cladding, detecting the visible light emitted from the first end surface of the optical fiber, and adjusting a relative angle of the optical device with respect to an alignment direction of the pair of stress application portions while determining the alignment direction based on a detection result in the detecting.

### BRIEF DESCRIPTION OF THE DRAWINGS

FIG. 1 is a perspective view illustrating an optical module according to an embodiment.

FIG. 2 is an exploded perspective view illustrating an optical module.

FIG. 3 is a diagram illustrating an end surface of a polarization maintaining fiber.

FIG. 4 is a diagram schematically illustrating a cross-section along an axial direction of a polarization maintaining fiber.

FIG. 5 is a flowchart illustrating a method of manufacturing an optical module according to an embodiment.

FIG. 6 is a diagram illustrating a state where an optical fiber holding portion is rotated about a central axis.

FIG. 7 is a diagram illustrating a state of a three-body alignment.

FIG. 8 is a diagram illustrating a configuration for observing an end surface of a polarization maintaining fiber.

FIG. 9 is a flowchart illustrating a method of manufacturing an optical module according to an embodiment.

FIG. 10 is a diagram conceptually illustrating a state of propagation of visible light when the visible light enters a polarization maintaining fiber from the outer periphery of a cladding.

FIG. 11 is an image of an end surface actually acquired by an image pickup apparatus.

FIG. 12 is a diagram illustrating a configuration in which an end surface of a polarization maintaining fiber is irradiated with visible light and the end surface is observed by an image pickup apparatus at the same time, as a comparative example.

FIG. 13 is an image of an end surface actually acquired by an image pickup apparatus in a comparative example.

FIG. 14 is a diagram illustrating an image of an end surface actually acquired by an image pickup apparatus when a distance between a light source and a polarization maintaining fiber is changed and an angle formed between an outer periphery of a cladding and an optical axis of visible light is changed.

FIG. 15 is a schematic diagram illustrating a state in which visible light enters a single mode fiber in a modification.

FIG. 16 is a schematic diagram illustrating a state in which visible light enters a single mode fiber in a modification.

FIG. 17 is a flowchart illustrating a method of manufacturing an optical module according to a modification.

FIG. 18 is a diagram conceptually illustrating a state of propagation of visible light when the visible light enters a single mode fiber from an outer periphery of a cladding.

FIG. 19 is an image of an end surface actually acquired by an image pickup apparatus.

### DETAILED DESCRIPTION

Conventionally, as an alignment method for optically coupling an optical fiber to an optical device, a method is known in which the relative position between the optical fiber and the optical device is adjusted while irradiating an end surface of the optical fiber with light and observing the end surface (Patent literature 1). In such a method, visibility is lowered due to influences such as reflection of light with which the end surface of the optical fiber is irradiated, and it is difficult to observe the end surface of the optical fiber. As a result, when the optical device is fixed to the optical fiber at an incorrect relative position, the optical coupling efficiency is reduced.

In addition, when the polarization maintaining fiber is optically coupled to the optical device, it is necessary to adjust a relative angle between the polarization maintaining fiber and the optical device. Even in this case, when the relative angle between the polarization maintaining fiber and the optical device is adjusted while irradiating the end surface of the polarization maintaining fiber with light and observing the end surface, visibility is lowered due to the influences such as reflection of the light with which the end surface of the polarization maintaining fiber is irradiated, and it is difficult to observe the end surface of the polarization maintaining fiber. As a result, when the optical device is fixed to the polarization maintaining fiber at an incorrect relative angle, the polarization extinction ratio characteristic is deteriorated.

An object of the present disclosure is to provide a method of manufacturing an optical module, which is capable of more accurately observing the respective end surfaces of the optical fiber and the polarization maintaining fiber, and accurately adjusting the relative position between the optical fiber and the optical device and the relative angle between the polarization maintaining fiber and the optical device.

According to the method of manufacturing an optical module according to the present disclosure, it is possible to more accurately observe the respective end surfaces of the optical fiber and the polarization maintaining fiber, and to accurately adjust the relative position between the optical fiber and the optical device and the relative angle between the polarization maintaining fiber and the optical device.

### Description of Embodiments of Present Disclosure

First, the contents of the embodiments of the present disclosure will be listed and described.
(1) A method of manufacturing an optical module according to an embodiment of the present disclosure is a method of manufacturing an optical module including an optical fiber and an optical device, the optical fiber being a polarization maintaining fiber having a core, a cladding covering an outer periphery of the core, and a first end surface at which the core and the cladding are exposed, the cladding including a pair of stress application portions, the core being located between the pair of stress application portions, the optical device being optically coupled to the optical fiber. The manufacturing method includes causing visible light to enter the optical fiber from an outer periphery of the cladding, detecting the visible light emitted from the first end surface of the optical fiber, and adjusting a relative angle of the optical device with respect to an alignment direction of the pair of stress application portions while determining the alignment direction based on a detection result in the detecting.

The manufacturing method according to (1) causes visible light to enter the polarization maintaining fiber from the outer periphery of the cladding, and detects the visible light emitted from the first end surface. In this case, the visible light entering the polarization maintaining fiber propagates through the cladding except for the stress application portion and reaches the first end surface of the polarization maintaining fiber. Thus, the contrast in light intensity between the stress application portion and the surrounding cladding thereof is noticeable, so that the boundary between the stress application portion and the surrounding cladding thereof can be clearly observed. Further, unlike the case where the first end surface of the polarization maintaining fiber is irradiated with light, the influences such as reflection of visible light is also suppressed. Thus, according to the manufacturing method according to (1), the end surface of the polarization maintaining fiber can be more accurately observed, and the relative angle between the polarization maintaining fiber and the optical device can be adjusted with high accuracy.
(2) The manufacturing method according to (1) may further include adjusting a relative position of the optical fiber with respect to the optical device so that an optical coupling efficiency between the optical fiber and the optical device approaches a maximum while causing laser light to enter the core at a second end surface opposite to the first end surface of the optical fiber after the adjusting the relative angle, and fixing the optical fiber of which relative position is adjusted and the optical device to each other. In this case, the relative position of the polarization maintaining fiber with respect to the optical device can be aligned with high accuracy, and the optical coupling efficiency can be enhanced.
(3) In the manufacturing method according to (1), in the adjusting the relative angle, the relative angle may be adjusted so that a polarization plane of light emitted from the optical device is parallel or orthogonal to the alignment direction of the pair of stress application portions. In this case, the polarization extinction ratio characteristic of the polarization maintaining fiber can be enhanced.
(4) A method of manufacturing an optical module according to an embodiment of the present disclosure is a method of manufacturing an optical module including an optical fiber having a core, a cladding covering an outer periphery of the core, and a first end surface at which the core and the cladding are exposed, and an optical device optically coupled to the optical fiber. The manufacturing method includes causing visible light to enter the optical fiber from an outer periphery of the cladding, detecting the visible light emitted from the first end surface of the optical fiber, and adjusting a relative position of the optical fiber with respect to the optical device while determining a position of the optical fiber based on a detection result in the detecting.

The manufacturing method according to (4) causes visible light to enter the optical fiber from the outer periphery of the cladding, and detects the visible light emitted from the first end surface. In this case, the visible light entering the optical fiber propagates through the cladding and reaches the first end surface of the optical fiber. Thus, the contrast in light intensity between the cladding and the surrounding region thereof is noticeable, so that the boundary between the cladding and the surrounding region thereof can be clearly observed. Further, unlike the case where the first end surface of the optical fiber is irradiated with light, the influences such as reflection of visible light is also suppressed. Thus, according to the manufacturing method according to (4), it is possible to more accurately observe the end surface of the optical fiber and to accurately adjust the relative position between the optical fiber and the optical device.
(5) In the method of manufacturing according to any one of (1) to (4), the optical fiber may further include a resin covering that covers the outer periphery of the cladding and transmits the visible light. In the causing the visible light to enter the optical fiber, the visible light may enter the optical fiber from an outer periphery of the resin covering. In this case, visible light can enter the optical fiber while protecting the cladding by the resin covering.
(6) In the method of any one of (1) to (4), in the causing the visible light to enter the optical fiber, an angle formed between the outer periphery of the cladding and an optical axis of the visible light may be 5 degrees to 30 degrees. In this case, visible light can efficiently enter the optical fiber.

### Details of Embodiments of Present Disclosure

Specific examples of the present disclosure are described below with reference to the drawings. The present disclosure is not limited to the examples, but is defined by the scope of the claims, and is intended to include all modifications within the meaning and scope equivalent to the scope of the claims. In the following description, the same elements are denoted by the same reference signs in the description of the drawings, and redundant description will be omitted.

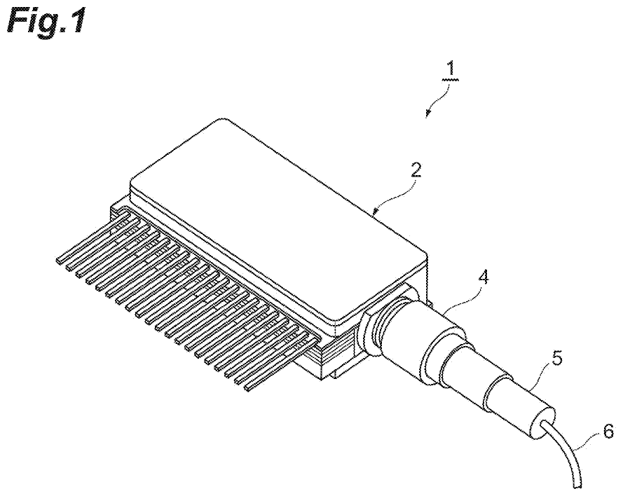

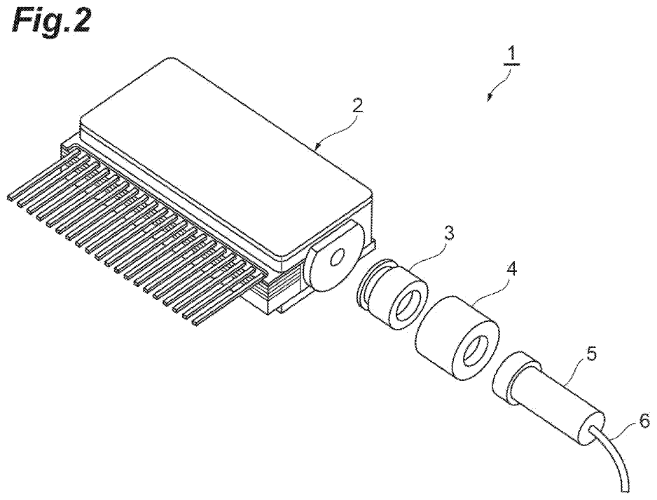

FIG. 1 is a perspective view illustrating an optical module 1 according to an embodiment of the present disclosure. FIG. 2 is an exploded perspective view illustrating the optical module 1. As illustrated in FIGS. 1 and 2, the optical module 1 of the embodiment includes an optical transmission device 2, a lens holder 3, a joint sleeve 4, an optical fiber holding portion 5, and a polarization maintaining fiber (PMF) 6. The optical transmission device 2 is an optical device optically coupled to the PMF 6. The optical transmission device 2 is a light source for generating two optical signals different from each other, and is a main component of the optical module 1. The optical transmission device 2 superimposes the two optical signals by making the polarization planes of the two optical signals orthogonal to each other, and outputs the two optical signals as one optical signal.

The lens holder 3 is a cylindrical member. The first end surface of the lens holder 3 is fixed to one side surface of the optical transmission device 2. The lens holder 3 holds a lens for condensing output light from the optical transmission device 2 inside. The lens of the lens holder 3 guides the output light from the optical transmission device 2 to the optical fiber holding portion 5. The joint sleeve 4 is a cylindrical member. The joint sleeve 4 is disposed between the second end surface of the lens holder 3 and the end surface of the optical fiber holding portion 5, and is fixed to both the lens holder 3 and the optical fiber holding portion 5, thereby fixing the lens holder 3 and the optical fiber holding portion 5 to each other. The optical fiber holding portion 5 is a columnar member and holds an end portion of the PMF 6. The PMF 6 is an optical fiber for transmitting an optical signal while maintaining the polarization state of the optical signal. The end surface of the PMF 6 is optically coupled to the lens of the lens holder 3.

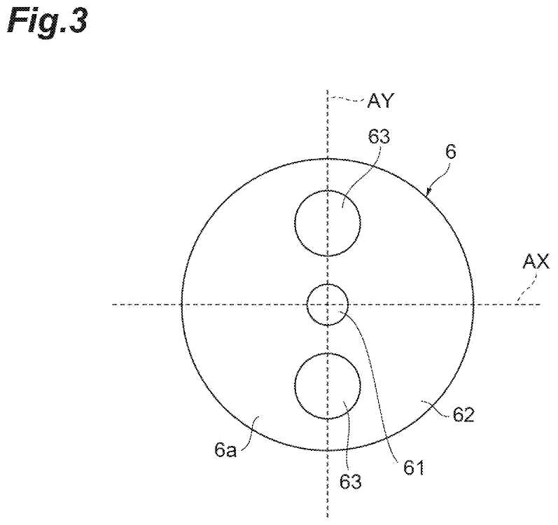

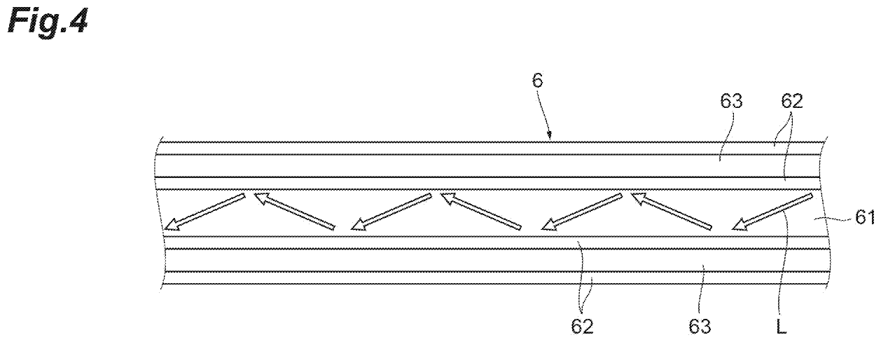

FIG. 3 is a diagram illustrating an end surface 6a (first end surface) of the PMF 6. FIG. 4 is a diagram schematically illustrating a cross-section of the PMF 6 along an axial direction. As illustrated in FIGS. 3 and 4, the PMF 6 has a core 61 and a cladding 62. At the end surface 6a, the core 61 and the cladding 62 are exposed. The core 61 is a central portion for transmitting an optical signal L, and is formed of a material having a high refractive index. The cladding 62 is a portion that covers the outer periphery of the core 61 and surrounds the core 61, and is formed of a material having a refractive index lower than that of the core 61. Thus, the optical signal L is confined in the core 61 and efficiently transmitted.

The cladding 62 includes a pair of stress application portions 63. The pair of stress application portions 63 are disposed within the cladding 62 and are symmetrically disposed around the core 61. In other words, the first stress application portion 63, the core 61, and the second stress application portion 63 are arranged in this order in a direction perpendicular to the axial direction of the PMF 6, and in the direction, the core 61 is located between the first stress application portion 63 and the second stress application portion 63. The pair of stress application portions 63 are formed of a specific material, and provide polarization maintaining characteristics by applying mechanical stress to the core 61. Specifically, the pair of stress application portions 63 applies stress to the core 61 in different axial directions, and maintains the polarization state of the optical signal L.

In FIG. 3, AX indicates an X-polarization plane (fast axis), and AY indicates a Y-polarization plane (slow axis). The X-polarization plane AX indicates a direction in which the optical signal L propagates at a high speed, and the Y-polarization plane AY indicates a direction in which the optical signal L propagates at a low speed. Thus, the PMF 6 can transmit the optical signal L while maintaining the polarization state of the optical signal L.

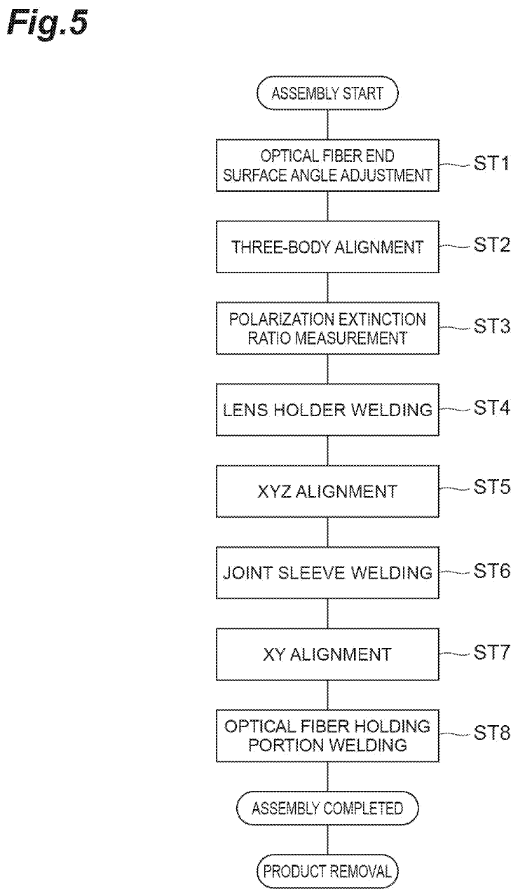

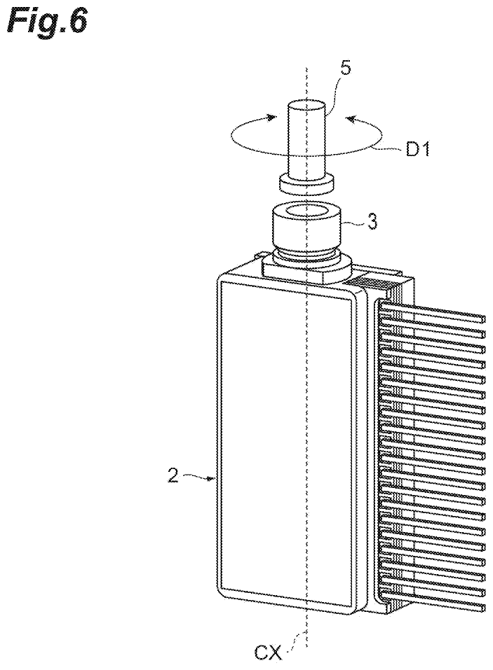

FIG. 5 is a flowchart for explaining a method of manufacturing the optical module 1 according to the embodiment. As illustrated in FIG. 5, the method according to the embodiment includes the following steps ST1 to ST8. First, in the step ST1, as illustrated in FIG. 6, the optical fiber holding portion 5 (or the optical transmission device 2) is rotated about a central axis CX (arrow D1 in the figure). Thus, the end surface 6a of the PMF 6 is rotated around the axis of the PMF 6, and an arrangement direction of the pair of stress application portions 63, that is, the relative angle of the optical transmission device 2 with respect to the Y-polarization plane is adjusted. Then, the X-polarization plane AX and the Y-polarization plane AY of the optical signal L output from the optical transmission device 2 respectively correspond with the fast axis and slow axis of the PMF 6. The step ST1 will be described in detail later.

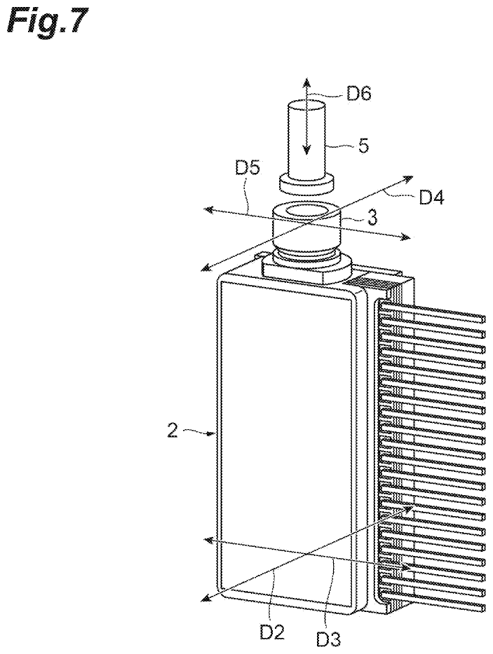

In the step ST2, three bodies of the optical transmission device 2, the lens holder 3, and the optical fiber holding portion 5 are aligned. This step ST2 causes the laser light to enter the core 61 of the end surface (second end surface) on the opposite side of the end surface 6a of the PMF 6. Then, the relative position between the PMF 6 and the optical transmission device 2 is adjusted so that the optical coupling efficiency between the PMF 6 and the optical transmission device 2 approaches a maximum. Specifically, as illustrated in FIG. 7, the position adjustment of the optical transmission device 2 along a direction D2 and a direction D3 that are orthogonal to the central axis CX and orthogonal to each other, the position adjustment of the lens holder 3 along a direction D4 and a direction D5 that are orthogonal to the central axis CX and orthogonal to each other, and the position adjustment of the optical fiber holding portion 5 in a direction D6 along the central axis CX are performed. Thus, the optical transmission device 2, the lens holder 3, and the optical fiber holding portion 5 are accurately aligned, and the optical signal L is efficiently transmitted.

In the step ST3, the polarization extinction ratio of the PMF 6 is measured. In this step ST3, measurement is performed to confirm whether the polarization state of the optical signal L is appropriately maintained. Here, the polarization extinction ratio (polarization crosstalk) is a numerical value representing the polarization maintaining ability of the PMF 6. The polarization extinction ratio is an intensity ratio between an original polarization mode and a leaked polarization mode orthogonal to the original polarization mode at one end surface of the PMF 6 when a linear polarization is incident from the other end surface with respect to one polarization mode of the X-polarization or the Y-polarization. The unit of the polarization extinction ratio is dB.

In the step ST4, the lens holder 3 is fixed to the housing of the optical transmission device 2. The fixing method is, for example, YAG welding. In this step ST4, the lens holder 3 is fixed to the optical transmission device 2 in a state where the lens holder 3 is accurately aligned with the optical transmission device 2. In the step ST5, while causing the laser light to enter the core 61 of the second end surface of the PMF 6, the relative position of the joint sleeve 4 and the optical transmission device 2 in the direction along the central axis CX and in the two directions orthogonal to the central axis CX is adjusted so that the optical coupling efficiency between the PMF 6 and the optical transmission device 2 approach the maximum (XYZ-alignment). In the step ST6, the joint sleeve 4 is fixed to the lens holder 3. The fixing method is, for example, YAG welding.

In the step ST7, while causing the laser light to enter the core 61 of the second end surface of the PMF 6, the relative position between the optical fiber holding portion 5 (PMF 6) and the optical transmission device 2 is adjusted in two directions orthogonal to the central axis CX so that the optical coupling efficiency between the PMF 6 and the optical transmission device 2 approaches the maximum (XY alignment). In the step ST8, the optical fiber holding portion 5 is fixed to the joint sleeve 4. The fixing method is, for example, YAG welding. After all the alignment and welding operations are completed, the assembly of the optical module 1 is completed, and the optical module 1 is removed from a jig.

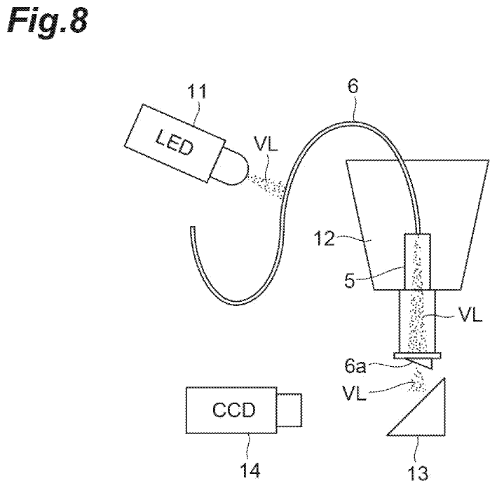

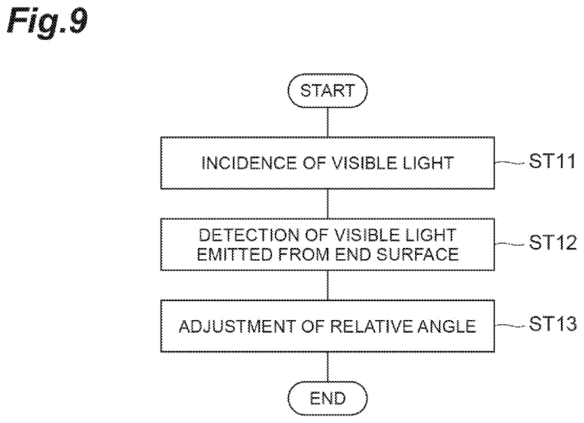

Here, the step ST1 will be described in detail. FIG. 8 is a diagram illustrating a configuration for observing the end surface 6a of the PMF 6 in the step ST1. FIG. 9 is a flowchart illustrating a step ST11, a step ST12, and a step ST13 included in the step ST1. In the step ST11, visible light VL starts to enter the side surface of the PMF 6. Specifically, a light source 11 generates the visible light VL. As the light source 11, various light sources capable of generating visible light, such as an LED, can be used. The LED is, for example, a white LED, a blue LED, a red LED, or a green LED. The light source 11 is not limited to an LED. The wavelength of the visible light VL is, for example, 380 nm to 770 nm. The visible light VL enters the PMF 6 from the side surface of the PMF 6 in the state of an optical fiber, that is, from the outer periphery of the cladding 62 through a primary resin covering. The optical fiber holding portion 5 for holding the PMF 6 is supported by a chuck 12.

In the step ST12, while causing the visible light VL to continuously enter the side surface of the PMF 6, the visible light VL emitted from the end surface 6a of the PMF 6 is detected to observe the end surface 6a. That is, the visible light VL reaching the end surface 6a of the PMF 6 is reflected from a prism mirror 13 and observed by an image pickup apparatus 14. The image pickup apparatus 14 is configured by, for example, a CCD camera, and can capture an image of the state of the end surface 6a of the PMF 6 with high accuracy.

In the step ST13, the relative angle of the optical transmission device 2 with respect to the arrangement direction of the pair of stress application portions 63 of the PMF 6, that is, with respect to the Y-polarization plane is adjusted. In the step ST13, the arrangement direction of the pair of stress application portions 63 is determined based on the detection result (observation result) of the step ST12, and the angle of the chuck 12 around the central axis CX is adjusted, thereby adjusting the relative angle of the optical transmission device 2 with respect to the arrangement direction. Specifically, the relative angle is adjusted so that the polarization plane of the optical signal L emitted from the optical transmission device 2 is parallel or orthogonal to the arrangement direction of the pair of stress application portions 63.

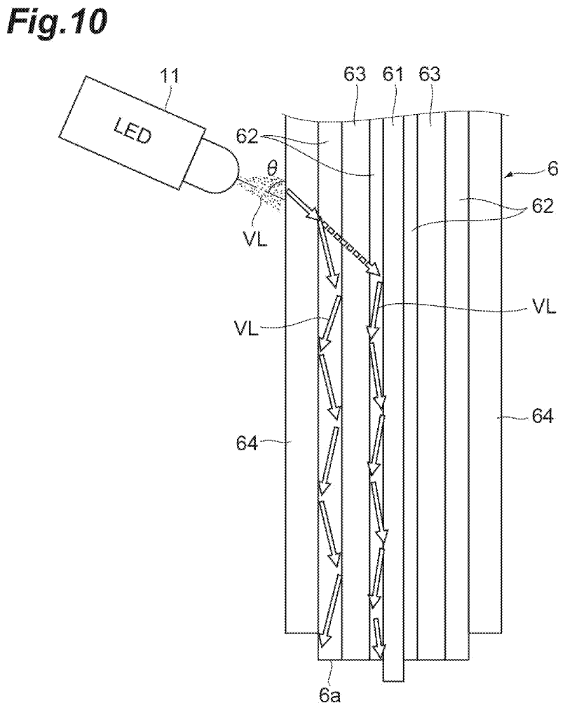

The effects obtained by the method of manufacturing the optical module 1 according to the embodiment described above will be described. In the manufacturing method according to the embodiment, in the step ST11 and the step ST12, the visible light VL enters the PMF 6 from the outer periphery of the cladding 62, and the visible light VL emitted from the end surface 6a is detected. FIG. 10 is a diagram conceptually illustrating a state of propagation of the visible light VL when the visible light VL enters the PMF 6 from the outer periphery of the cladding 62. The visible light VL enters the PMF 6 from the outer periphery of the cladding 62 through a resin covering 64 (primary coating, for example, UV resin) of the PMF 6. As illustrated in FIG. 10, the visible light VL entering the PMF 6 is refracted or irregularly reflected at the boundary between the resin covering 64 and the cladding 62 and at the boundary between the stress application portion 63 and the portion of the cladding 62 excluding the stress application portion 63, and is totally reflected at the boundary between the cladding 62 and the core 61. Thus, the visible light VL propagates through the cladding 62 excluding the stress application portion 63 and reaches the end surface 6a of the PMF 6.

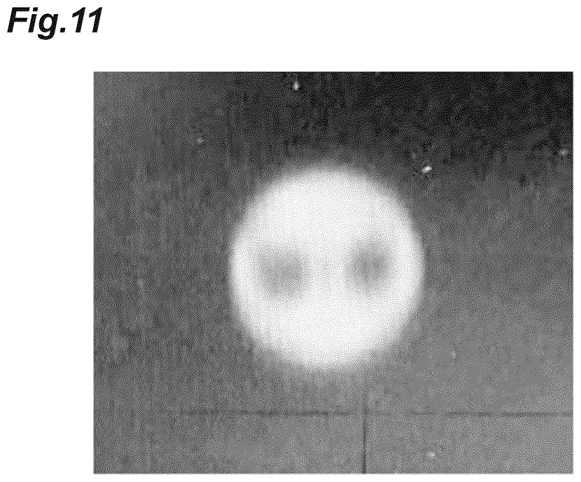

FIG. 11 is an image of the end surface 6a actually acquired by the image pickup apparatus 14. Referring to FIG. 11, the contrast in light intensity is noticeable between the stress application portion 63 and the surrounding cladding 62. As described above, according to the step ST1 of the embodiment, the contrast in the visible light VL is noticeable between the stress application portion 63 and the surrounding cladding 62, and thus the boundary between the stress application portion 63 and the surrounding cladding 62 thereof can be clearly observed.

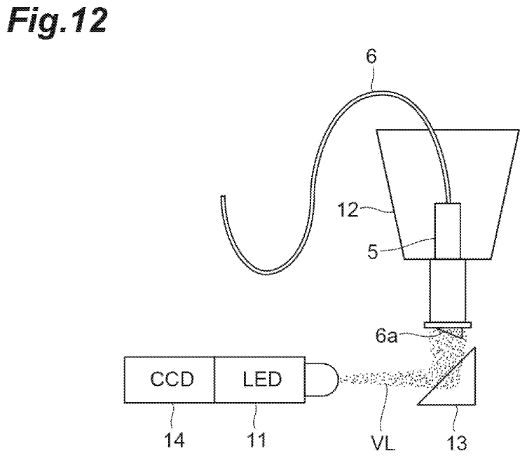

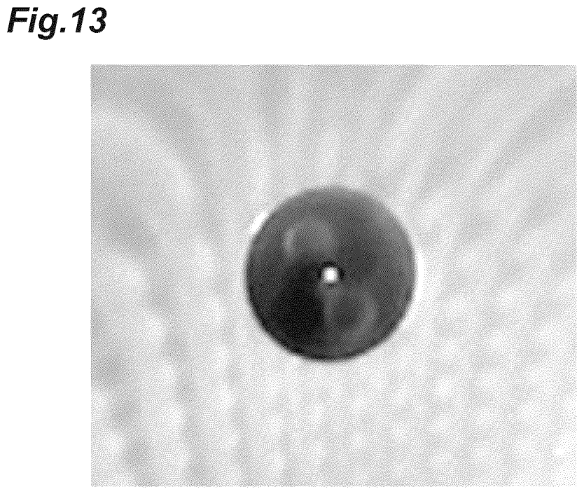

Further, FIG. 12 is a diagram illustrating a configuration in which the end surface 6a of the PMF 6 is irradiated with the visible light VL and the end surface 6a is observed by the image pickup apparatus 14 at the same time, as a comparative example. FIG. 13 is an image of the end surface 6a actually acquired by the image pickup apparatus 14 in this comparative example. Referring to FIG. 13, it is understood that the visibility is lowered due to the influences such as reflection of the visible light VL with which the end surface 6a of the PMF 6 is irradiated, and the end surface 6a of the PMF 6 is difficult to observe. In particular, the boundary between the stress application portion 63 and the surrounding cladding 62 thereof is unclear. As a result, when the optical transmission device 2 is fixed to the PMF 6 at an incorrect relative angle, the polarization extinction ratio characteristic is deteriorated. In contrast, according to the step ST1 of the embodiment, unlike the comparative example in which the end surface 6a of the PMF 6 is irradiated with the visible light VL, the influences such as reflection of the visible light VL is suppressed.

As described above, according to the manufacturing method of the embodiment, the end surface 6a of the PMF 6 can be more accurately observed, and the relative angle between the PMF 6 and the optical transmission device 2 can be adjusted with high accuracy.

As in the embodiment, after the step ST1, a step (step ST2, step ST5, and step ST7) of adjusting the relative position between the PMF 6 and the optical transmission device 2 so that the optical coupling efficiency between the PMF 6 and the optical transmission device 2 approaches the maximum while causing the laser light to enter the core 61 of the end surface on the opposite side of the end surface 6a of the PMF 6, and a step (step ST4, step ST6, and step ST8) of fixing the PMF 6 and the optical transmission device 2 whose relative positions have been adjusted to each other may be further performed. In this case, the relative position between the PMF 6 and the optical transmission device 2 can be accurately aligned, and the optical coupling efficiency can be enhanced.

As in the embodiment, in the step ST13, the relative angle may be adjusted so that the polarization plane of the light emitted from the optical transmission device 2 is parallel or orthogonal to the arrangement direction of the pair of stress application portions 63. In this case, the polarization extinction ratio characteristic of the PMF 6 can be enhanced.

As in the embodiment, the PMF 6 may include the resin covering 64 that covers the outer periphery of the cladding 62 and transmits the visible light VL. In the step ST11, the visible light VL may enter the PMF 6 from the outer periphery of the resin covering 64. In this case, the visible light VL can enter the PMF 6 while the cladding 62 is protected by the resin covering 64.

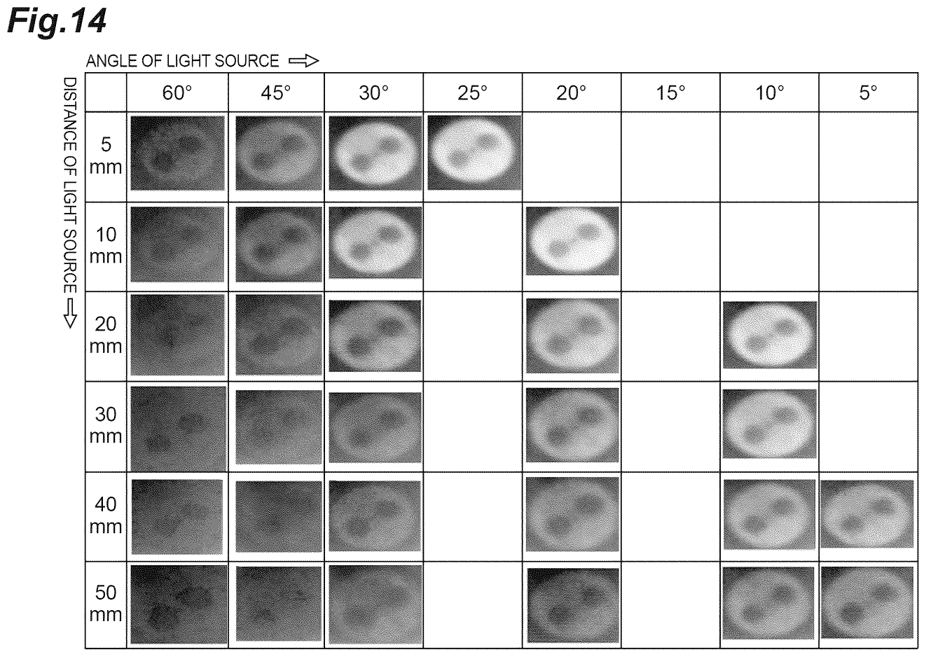

Here, FIG. 14 is a diagram illustrating an image of the end surface 6a actually acquired by the image pickup apparatus 14 when a distance between the light source 11 and the PMF 6 is changed from 5 mm to 50 mm and an angle θ (see FIG. 10) formed between the outer periphery of the cladding 62 and the optical axis of the visible light VL is changed from 5 degrees to 60 degrees in the step ST11. As illustrated in FIG. 14, when the angle θ is 5 degrees to 30 degrees, more preferably 10 degrees to 25 degrees, the visible light VL can efficiently enter the PMF 6, and the image of the end surface 6a can be made clearer.

### Modification

In the above embodiment, the method of manufacturing the optical module 1 including the PMF 6 and the optical transmission device 2 optically coupled to the PMF 6 has been described. In the modification, a method of manufacturing an optical module including a single mode fiber and an optical transmission device optically coupled to the single mode fiber will be described. In the modification, the step ST2 to step ST8 excluding the step ST1 are performed among the step ST1 to the step ST8 illustrated in FIG. 5 of the above embodiment. Then, in the step ST2, the end surface of the single mode fiber is observed while causing visible light to enter from the outer periphery of the cladding of the single mode fiber.

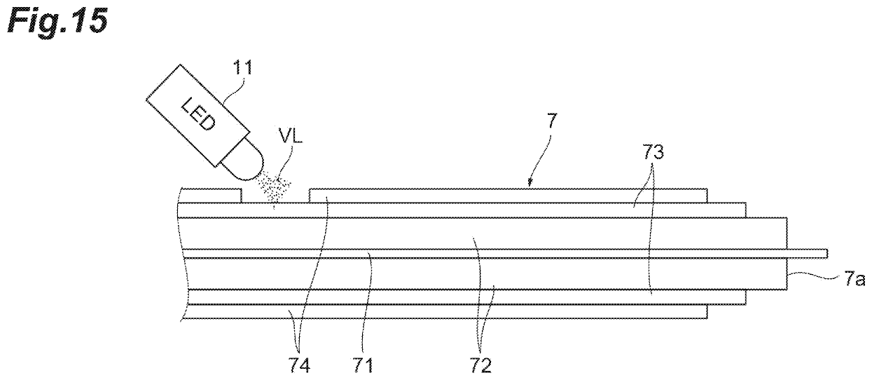

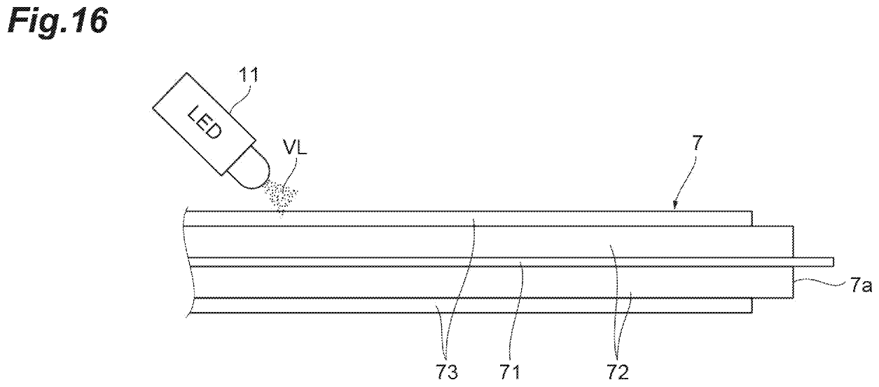

FIGS. 15 and 16 are diagrams schematically illustrating a state in which the visible light VL enters a single mode fiber (SMF) 7 in the modification. The SMF 7 includes a core 71, a cladding 72 covering the outer periphery of the core 71, a primary resin covering 73 covering the outer periphery of the cladding 72, and an end surface 7a (first end surface) where the core 71 and the cladding 72 are exposed. The SMF 7 further includes a secondary resin covering 74 that covers the outer periphery of the primary resin covering 73 as necessary. The above embodiment causes the visible light VL to enter from the outer periphery of the cladding 62 when adjusting the relative angle between the PMF 6 and the optical transmission device. The modification causes the visible light VL to enter from the outer periphery of the cladding 72 in a step (step ST2) of a three-body alignment adjusting the relative position between the SMF 7 and the optical transmission device. Then, as in FIG. 8, the image pickup apparatus 14 is used to detect the visible light VL emitted from the end surface 7a, and the end surface 7a is observed.

Note that, as illustrated in FIG. 15, the visible light VL may enter the SMF 7 from the outer periphery of the primary resin covering 73 exposed by removing a part of the secondary resin covering 74, or as illustrated in FIG. 16, the visible light VL may enter the SMF 7 from the outer periphery of the primary resin covering 73 in a state where the secondary resin covering 74 is completely removed.

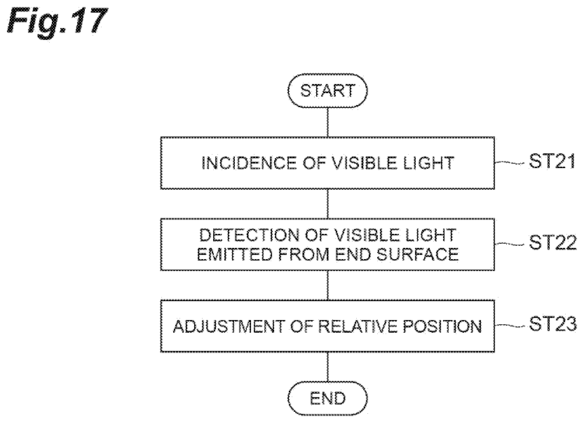

FIG. 17 is a flowchart illustrating a step ST21, a step ST22, and a step ST23 included in the step ST2 of the modification. In the step ST21, the visible light VL starts to enter the side surface of the SMF 7. Specifically, the light source 11 (see FIG. 8) generates the visible light VL. The visible light VL enters the SMF 7 from the side surface of the SMF 7 in the state of an optical fiber, that is, from the outer periphery of the cladding 72 through the primary resin covering 73.

In the step ST22, while causing the visible light VL to continuously enter the side surface of the SMF 7, the visible light VL emitted from the end surface 7a of the SMF 7 is detected to observe the end surface 7a. That is, the visible light VL reaching the end surface 7a of the SMF 7 is reflected from the prism mirror 13 and observed by the image pickup apparatus 14 (see FIG. 8). In the step ST23, the position of the SMF 7 is determined based on the detection result (observation result) of the step ST22, and the relative position between the SMF 7 and the optical transmission device is adjusted by a method similar to the method of the above-described three-body alignment.

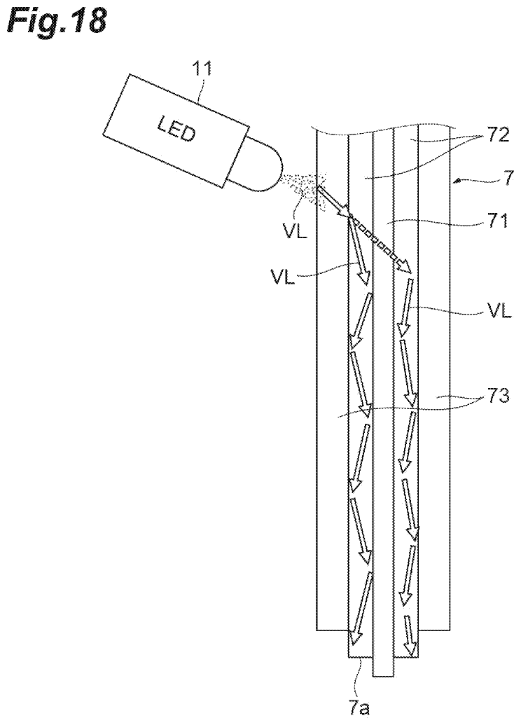

In the modification, the visible light VL enters the SMF 7 from the outer periphery of the cladding 72, and the visible light VL emitted from the end surface 7a is detected. FIG. 18 is a diagram conceptually illustrating a state of propagation of the visible light VL when the visible light VL enters the SMF 7 from the outer periphery of the cladding 72. The visible light VL enters the SMF 7 from the outer periphery of the cladding 72 through the primary resin covering 73 of the SMF 7. As illustrated in FIG. 18, the visible light VL entering the SMF 7 is refracted or irregularly reflected at the boundary between the primary resin covering 73 and the cladding 72, and is totally reflected at the boundary between the cladding 72 and the core 71. Thus, the visible light VL propagates through the cladding 72 and reaches the end surface 7a of the SMF 7.

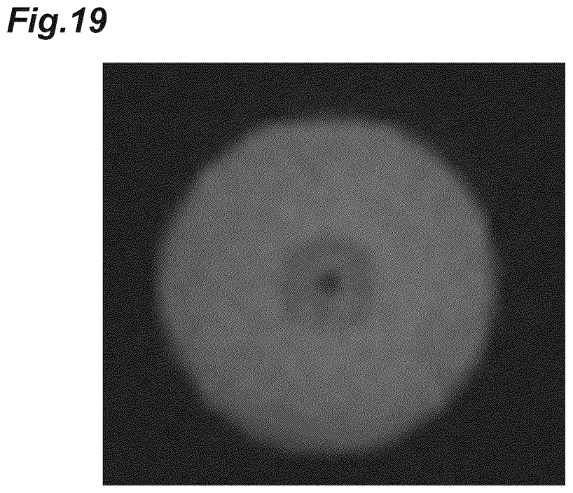

FIG. 19 is an image of the end surface 7a actually acquired by the image pickup apparatus 14. Referring to FIG. 19, it is understood that the contrast in light intensity between the cladding 72 and the surrounding region thereof is noticeable. As described above, according to the modification, the contrast in the visible light VL is noticeable between the cladding 72 and the surrounding region thereof, and thus, the boundary between the cladding 72 and the surrounding region thereof can be clearly observed. Further, according to the modification, unlike the case where the end surface 7a of the SMF 7 is irradiated with the visible light VL, the influences such as reflection of the visible light VL is suppressed. As described above, according to the modification, the end surface 7a of the SMF 7 can be observed more accurately, and the relative position between the SMF 7 and the optical transmission device can be adjusted with high accuracy.

As in the modification, the SMF 7 may include the primary resin covering 73 that covers the outer periphery of the cladding 72 and transmits the visible light VL. In the step ST21, the visible light VL may enter the SMF 7 from the outer periphery of the primary resin covering 73. In this case, the visible light VL can enter the SMF 7 while the cladding 72 is protected by the primary resin covering 73.

In addition, in the modification, when the angle formed between the outer periphery of the cladding 72 and the optical axis of the visible light VL is 5 degrees to 30 degrees, more preferably 10 degrees to 25 degrees, the visible light VL can efficiently enter the SMF 7, and the image of the end surface 7a can be made clearer.

The method of manufacturing an optical module according to the present disclosure is not limited to the above-described embodiment, and various modifications may be made.

What is claimed is:

1. A method of manufacturing an optical module including an optical fiber and an optical device, the optical fiber having a core, a cladding covering an outer periphery of the core, and a first end surface at which the core and the cladding are exposed, the cladding including a pair of stress application portions, the core being a polarization maintaining fiber located between the pair of stress application portions, the optical device being optically coupled to the optical fiber, the method comprising:
causing visible light to enter the optical fiber from an outer periphery of the cladding;
detecting the visible light emitted from the first end surface of the optical fiber; and
adjusting a relative angle of the optical device with respect to an alignment direction of the pair of stress application portions while determining the alignment direction based on a detection result in the detecting.

2. The method of manufacturing an optical module according to claim 1, the method further comprising:
adjusting a relative position of the optical fiber with respect to the optical device so that an optical coupling efficiency between the optical fiber and the optical device approaches a maximum while causing laser light to enter the core at a second end surface opposite to the first end surface of the optical fiber after the adjusting the relative angle; and
fixing the optical fiber of which relative position is adjusted and the optical device to each other.

3. The method of manufacturing an optical module according to claim 1,
wherein, in the adjusting the relative angle, the relative angle is adjusted so that a polarization plane of light emitted from the optical device is parallel or orthogonal to the alignment direction of the pair of stress application portions.

4. The method of manufacturing an optical module according to claim 1,
wherein the optical fiber further includes a resin covering that covers the outer periphery of the cladding and transmits the visible light, and
wherein, in the causing the visible light to enter the optical fiber, the visible light enters the optical fiber from an outer periphery of the resin covering.

5. The method of manufacturing an optical module according to claim 1,
wherein, in the causing the visible light to enter the optical fiber, an angle formed between the outer periphery of the cladding and an optical axis of the visible light is 5 degrees to 30 degrees.

6. A method of manufacturing an optical module including an optical fiber having a core, a cladding covering an outer periphery of the core, and a first end surface at which the core and the cladding are exposed, and an optical device optically coupled to the optical fiber, the method comprising:
causing visible light to enter the optical fiber from an outer periphery of the cladding;
detecting the visible light emitted from the first end surface of the optical fiber; and
adjusting a relative position of the optical fiber with respect to the optical device while determining a position of the optical fiber based on a detection result in the detecting.

7. The method of manufacturing an optical module according to claim 6,
wherein the optical fiber further includes a resin covering that covers the outer periphery of the cladding and transmits the visible light, and
wherein, in the causing the visible light to enter the optical fiber, the visible light enters the optical fiber from an outer periphery of the resin covering.

8. The method of manufacturing an optical module according to claim 6,
wherein, in the causing the visible light to enter the optical fiber, an angle formed between the outer periphery of the cladding and an optical axis of the visible light is 5 degrees to 30 degrees.
